(19) United States
(12) Patent Application Publication
(10) Pub. No.: US 2023/0118058 A1
(43) Pub. Date: Apr. 20, 2023

(54) SYSTEMS AND METHODS FOR ACCELERATING A NEURAL NETWORK USING A UNIFIED SPARSE TENSOR CORE

(71) Applicant: TENCENT AMERICA LLC, Palo Alto, CA (US)

(72) Inventors: Wei WANG, Palo Alto, CA (US); Wei JIANG, Sunnyvale, CA (US); Shan LIU, San Jose, CA (US)

(73) Assignee: TENCENT AMERICA LLC, Palo Alto, CA (US)

(21) Appl. No.: 17/956,036

(22) Filed: Sep. 29, 2022

Related U.S. Application Data
(60) Provisional application No. 63/289,035, filed on Dec. 13, 2021.
(60) Provisional application No. 63/257,014, filed on Oct. 18, 2021.

(51) Int. Cl. G06N 3/08; G06F 17/16

(52) U.S. Cl. CPC G06N 3/082; G06F 17/16

(57) ABSTRACT

Provided are systems and methods for accelerating a neural network model. A method for accelerating a neural network model includes obtaining an original weight matrix corresponding to a trained neural network model, pruning the original weight matrix, retraining nonzero coefficients in the pruned weight matrix, compressing the retrained weight matrix, and performing a matrix multiplication operation based on inputting the compressed weight matrix and a set of input activations to the trained neural network model.

### CROSS-REFERENCE TO RELATED APPLICATIONS

This application claims priority to U.S. Provisional Application No. 63/257,014, filed on Oct. 18, 2021, and U.S. Provisional Application No. 63/289,035, filed on Dec. 13, 2021, in the U.S. Patent and Trademark Office, the disclosures of which are incorporated herein by reference in their entireties.

### BACKGROUND

### 1. Field

The disclosure relates to neural network model acceleration, and more specifically, to a unified sparse tensor core operation for neural network acceleration.

### 2. Description of Related Art

Deep Neural Networks (DNNs) are used to solve a wide range of tasks for computer vision, natural language processing, etc. The large model capacity of the deep network structures with a huge number of parameters leads to high prediction performance, but also makes DNN models too expensive to use in practice, especially for mobile and on-device applications with strong limitations on storage, computation power, and energy consumption. Therefore, reducing the cost of using DNN models has drawn attention in academia and industry.

Neural network compression is one way to reduce a size of large DNN models (i.e., the required storage) and to accelerate inference (e.g., classification), without sacrificing much performance (e.g., classification accuracy). Effective compression solutions usually require multidisciplinary knowledge from machine learning, computer architecture, hardware design, etc. Neural network compression may include different techniques, such as weight pruning, weight quantization, low-rank factorization, and knowledge distillation. Among all the efforts, weight pruning, and weight quantization are the most popular directions. In particular, weight pruning aims to remove unimportant weight coefficients and reduce redundancy in network connections of a trained neural network. Although a high compression rate can be achieved with little prediction loss, unstructured weight pruning methods cannot improve inference computation most of the time (and sometimes worsen the problem) due to the random memory access caused by the unstructured sparsity in the pruned weight matrix.

The NVIDIA Ampere GPU architecture introduced a concept of fine-grained structured sparsity to address the weakness of unstructured pruning. On the NVIDIA A100 GPU, the structure manifests as a 2:4 pattern: out of every four coefficients, at least two must be zero. However, these zero coefficients are located in an unstructured fashion. This approach reduced the data footprint and bandwidth of weight tensor by 2× and doubled throughput by skipping the computation of the zero values using new hardware NVIDIA Sparse Tensor Cores. However, the maximum sparse rate and throughput increase are limited to 2× due to the 2:4 sparse pattern utilized in this architecture. Removing more weights usually causes a large drop in prediction performance, especially for models like MobileNet that are already designed to be highly efficient.

### SUMMARY

Inference operations for deep learning systems use matrix multiplication intensively, so a high-performance general matrix-matrix multiplication (GEMM) is key for performing the inference operations. Provided are systems and methods for a uniform pattern based GEMM operation method to accelerate a neural network model.

According to an aspect of the disclosure, a method for accelerating a neural network model includes: obtaining an original weight matrix corresponding to a trained neural network model; pruning the original weight matrix; retraining nonzero coefficients in the pruned weight matrix; compressing the retrained weight matrix; and performing a matrix multiplication operation based on inputting the compressed weight matrix and a set of input activations to the trained neural network model.

Pruning the weight matrix may include pruning the weight matrix to meet a 2:4 sparse pattern, wherein at least two coefficients of the weight matrix are nonzero in each group of four coefficients of the weight matrix.

Retraining the weight matrix may include determining a smallest nonzero coefficient in each group of four coefficients of the pruned weight matrix, and retraining an absolute value of each nonzero coefficient in each group of four coefficients to be a power-of-two of the smallest nonzero coefficient in the group.

Compressing the weight matrix may include compressing the retrained weight matrix to be a quarter size of the original weight matrix, generating a nonzero flag array corresponding to the compressed weight matrix, generating a sign flag array corresponding to the compressed weight matrix, and generating a left-shift flag array corresponding to the compressed weight matrix. The nonzero flag array is a one-bit array that is used to keep track of nonzero coefficients in the original weight matrix, the sign flag array is a one-bit array that is used to keep track of a sign of the nonzero coefficients in the original weight matrix, and the left-shift flag array is a two-bit array that is used to keep track of a power-of-two relationship in each group of four coefficients.

Performing the matrix multiplication operation based on inputting the compressed weight matrix and a set of input activations to the trained neural network model may include: selecting input activations from the set of input activations, based on the nonzero flag array, wherein only input activations that correspond to the nonzero flag array are selected; and performing the matrix multiplication operation on the selected input activations, wherein multiplication operations corresponding to unselected input activations are skipped.

Performing the matrix multiplication operation on the selected input activations may include: converting multiple independent multiplication operations to a single multiplication operation and multiple addition operations, based on the sign flag array and the left-shift flag array; and performing the single multiplication operation and multiple addition operations using the selected input activations, based on the sign flag array and the left-shift flag array. In this way, a plurality of multiple independent multiplication operations, that correspond to an inference operation of the trained neural network model, are each converted to single multiplication operation and multiple addition operations, and a plurality of the single multiplication operations may be performed simultaneously.

The method may further include obtaining an output of the neural network model based on the matrix multiplication operation, the output corresponding to an inference operation of the neural network model.

According to an aspect of the disclosure, a device for accelerating a neural network model includes a memory storing instructions, and at least one processor configured to execute the instructions to: obtain an original weight matrix corresponding to a trained neural network model; prune the original weight matrix; retrain nonzero coefficients in the pruned weight matrix; compress the retrained weight matrix; and perform a matrix multiplication operation based on inputting the compressed weight matrix and a set of input activations to the trained neural network model.

The processor may be further configured to execute the instructions to: determine a smallest nonzero coefficient in each group of four coefficients of the pruned weight matrix; and retrain an absolute value of each nonzero coefficient in each group of four coefficients to be a power-of-two of the smallest nonzero coefficient in the group.

The processor may be further configured to execute the instructions to: compress the retrained weight matrix to be a quarter size of the original weight matrix; generate a nonzero flag array corresponding to the compressed weight matrix; generate a sign flag array corresponding to the compressed weight matrix; and generate a left-shift flag array corresponding to the compressed weight matrix.

The processor may be further configured to execute the instructions to: select input activations from the set of input activations, based on the nonzero flag array, wherein only input activations that correspond to the nonzero flag array are selected; and perform the matrix multiplication operation on the selected input activations, wherein multiplication operations corresponding to unselected input activations are skipped.

The processor may be further configured to execute the instructions to: convert multiple independent multiplication operations to a single multiplication operation and multiple addition operations, based on the sign flag array and the left-shift flag array; and perform the single multiplication operation and multiple addition operations using the selected input activations, based on the sign flag array and the left-shift flag array.

The plurality of multiple independent multiplication operations, that correspond to an inference operation of the trained neural network model, may each be converted to single multiplication operation and multiple addition operations, and a plurality of the single multiplication operations may be performed simultaneously.

The processor may be further configured to execute the instructions to: obtain an output of the neural network model based on the matrix multiplication operation, the output corresponding to an inference operation of the neural network model.

According to an aspect of the disclosure, a non-transitory computer readable medium for storing computer readable program code or instructions which are executable by a processor to perform operations for accelerating a neural network model, the operations including: obtaining an original weight matrix corresponding to a trained neural network model; pruning the original weight matrix; retraining nonzero coefficients in the pruned weight matrix; compressing the retrained weight matrix; performing a matrix multiplication operation based on inputting the compressed weight matrix and a set of input activations to the trained neural network model; and obtaining an output of the neural network model based on the matrix multiplication operation, the output corresponding to an inference operation of the neural network model.

The operations may further comprise: determining a smallest nonzero coefficient in each group of four coefficients of the pruned weight matrix; and retraining an absolute value of each nonzero coefficient in each group of four coefficients to be a power-of-two of the smallest nonzero coefficient in the group.

The operations may further comprise: compressing the retrained weight matrix to be a quarter size of the original weight matrix; generating a nonzero flag array corresponding to the compressed weight matrix; generating a sign flag array corresponding to the compressed weight matrix; and generating a left-shift flag array corresponding to the compressed weight matrix.

The operations may further comprise: converting multiple independent multiplication operations to a single multiplication operation and multiple addition operations, based on the sign flag array and the left-shift flag array; and performing the single multiplication operation and multiple addition operations using the selected input activations, based on the sign flag array and the left-shift flag array.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1 is a diagram illustrating components of one or more devices according to an various embodiments;

FIG. 2 is a diagram illustrating a unified sparse tensor core operation, according to various embodiments;

FIG. 3 is a diagram illustrating retraining of a weight matrix, according to various embodiments;

FIG. 4 is a diagram illustrating compression of a weight matrix, according to various embodiments;

FIG. 5 is a diagram illustrating matrix multiplication in a unified sparse tensor core, according to various embodiments; and

FIG. 6 is a flow diagram illustrating a method for accelerating a neural network model, according to various embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flow diagrams and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

As set forth above, neural network compression using unstructured weight pruning techniques may achieve a high compression rate with little prediction loss, but these techniques typically cannot improve inference operations, and sometimes even increase the prediction loss. A fine-grained structured sparsity technique may be manifest as a 2:4 pattern, where out of every four coefficients, at least two must be zero. This technique may reduce a data footprint and bandwidth of a weight tensor by half, and double an inference throughput by skipping computation of zero-value coefficients. However, the maximum sparse rate and inference throughput increase are limited to 2× due to the 2:4 sparse pattern.

Various embodiments according to the disclosure provide a system and method for a unified sparse tensor core operation. The unified sparse tensor core operation combines a fine-grained structured sparsity technique with a weight unification technique, to achieve higher inference throughput.

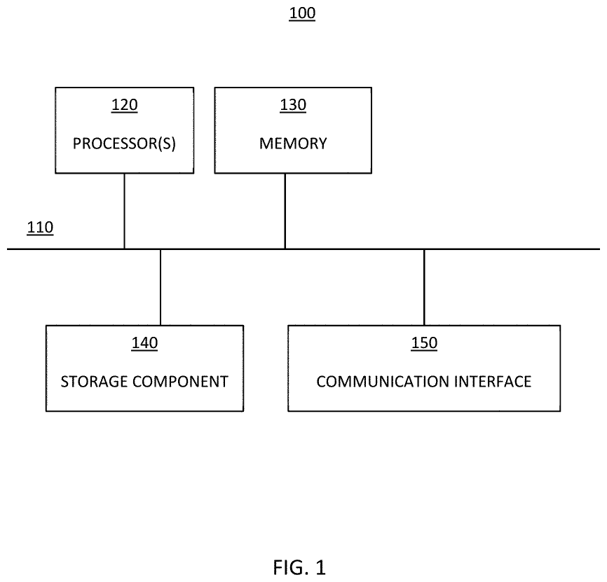

FIG. 1 is a diagram illustrating components of one or more devices according to an various embodiments. Referring to FIG. 1, the device 100 may include a bus 110, one or more processor(s) 120, a memory 130, a storage component 140, and a communication interface 150. It is understood that one or more of the components may be omitted and/or one or more additional components may be included.

The bus 110 includes a component that permits communication among the components of the device 100. The processor 120 may be implemented in hardware, firmware, or a combination of hardware and software. The processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a sparse tensor core, or another type of processing component. The processor 120 may include one or more processors. For example, the processor 120 may include one or more CPU, APU, FPGA, ASIC, sparse tensor core, or another type of processing component. The one or more processors of the processor 120 may be capable of being programmed to perform a function.

The memory 130 includes a random access memory (RAM), a read only memory (ROM), and/or another type of dynamic or static storage device (e.g., a flash memory, a magnetic memory, and/or an optical memory) that stores information and/or instructions for use by the processor 120.

The storage component 140 stores information and/or software related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The communication interface 150 includes a transceiver-like component (e.g., a transceiver and/or a separate receiver and transmitter) that enables the device 100 to communicate with other devices, such as via a wired connection, a wireless connection, or a combination of wired and wireless connections. The communication interface 150 may permit device 100 to receive information from another device and/or provide information to another device. For example, the communication interface 150 may include an Ethernet interface, an optical interface, a coaxial interface, an infrared interface, a radio frequency (RF) interface, a universal serial bus (USB) interface, a Wi-Fi interface, a cellular network interface, or the like.

The device 100 may perform one or more processes or functions described herein. The device 100 may perform operations based on the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 150. When executed, software instructions stored in the memory 130 and/or storage component 140 may cause the processor 120 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, device 100 may include additional components, fewer components, different components, or differently arranged components than those shown in FIG. 1. Additionally, or alternatively, a set of components (e.g., one or more components) of device 100 may perform one or more functions described as being performed by another set of components of device 100.

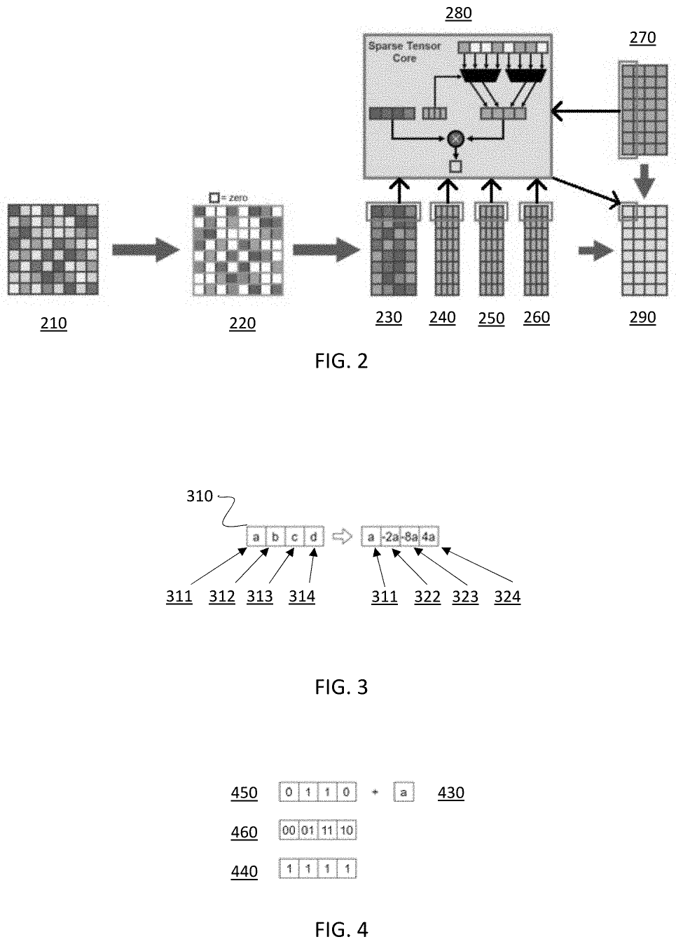

Any one of the operations or processes described below (e.g., FIGS. 2-6) may be implemented by or using any one of the elements illustrated in FIG. 1.

FIG. 2 is a diagram illustrating a unified sparse tensor core operation, according to various embodiments. As shown in FIG. 2, the unified sparse tensor core operation includes obtaining a weight matrix 210. For example, the device 100 may obtain the weight matrix 210 from the memory 130, the storage component 140, or a location external to the device 100 via the communication interface 150. The weight matrix 210 may include trained weights (e.g., coefficient values) corresponding to a trained neural network. For example, the weight matrix 210 may include weights corresponding to a neural network that has been trained to perform a classification task

The weight matrix 210 may be pruned to generate a pruned weight matrix 220. The weight matrix 210 may be pruned using a fine-grained structured sparsity technique with a 2:4 sparse pattern, such that at least two coefficients are nonzero in each group of four coefficients in the weight matrix 210. For example, the first through fourth coefficients in the weight matrix 210 may form a first group of coefficients, the fifth through eighth coefficients in the weight matrix 210 may form a second group of coefficients, the ninth through twelfth coefficients in the weight matrix 210 may form a third group of coefficients, etc. The first group of coefficients may be pruned such that at least two coefficients in the first group are nonzero, the second group of coefficients may be pruned such that at least two coefficients in the second group are nonzero, and the third group of coefficients may be pruned such that at least two coefficients in the third group are nonzero.

The coefficient values in the pruned weight matrix 220 may be retrained to generate a retrained weight matrix. For example, an absolute value of each nonzero coefficient in each group of four coefficients in the pruned weight matrix 220 may be retrained to be a power-of-two of the smallest nonzero coefficient in the group.

The retrained weight matrix may be compressed to generate a compressed weight matrix 230, a nonzero flag array 240, a sign flag array 250, and a left-shift flag array 260. The compressed weight matrix 230 may be compressed to quarter the size of the original matrix (weight matrix 220). The nonzero flag array 240 may be a one-bit array used to keep track of the nonzero coefficients in the original matrix (weight matrix 220). The sign flag array 250 may be a one-bit array used to keep track of the sign of the nonzero coefficients in the original matrix (weight matrix 220). The left-shift flag array 260 may be a two-bit array used to keep track of the power-of-two relationship in each group of four coefficients in the retrained pruned weight matrix.

The sparse tensor core 280 may be controlled to perform a matrix multiplication operation as part of an inference operation. The sparse tensor core 280 may perform the matrix multiplication based on the compressed weight matrix 230, the nonzero flag array 240, the sign flag array 250, the left-shift flag array 260, and an input activation matrix 270, to obtain an output activation. Corresponding values in the compressed weight matrix 230 (i.e., weight coefficients), nonzero flag array 240 (i.e., nonzero flags), sign flag array 250 (i.e., sign flags), left-shift flag array 260 (i.e., left-shift flags), and input activation matrix 270 (i.e., input activation coefficients) may be input to the sparse tensor core 280. For example, as shown in FIG. 2, the weight coefficients within a subset 231 of the compressed weight matrix 230, the nonzero flag values within a subset 241 of the nonzero flag array 240, the sign flag values within a subset 251 of the sign flag array 250, the left-shift flag values within a subset 261 of the left-shift flag array 260, and the input activation values within a subset 271 of the input activation matrix 270 may be corresponding values. The values within the subsets 231, 241, 251, 261, and 271 may be provided as input to the sparse tensor core 280.

The sparse tensor core 280 may select input activation values based on the nonzero flags, and calculate a dot product with the selected activations. The sparse tensor core 280 may calculate the dot product between the selected activations and their corresponding coefficients in the compressed weight matrix 230, based on the sign flags and left-shift flags. The sparse tensor core 280 may provide the dot product result as an output. The dot product result may be obtained as an output activation coefficient value, and stored in an output activation matrix 290.

FIG. 3 is a diagram illustrating retraining of a weight matrix, according to various embodiments. For example, the device 100 may obtain the pruned weight matrix 220 and retrain the coefficients in each group of four coefficients in the pruned weight matrix 220. As shown in FIG. 3, a group of four coefficients 310 may include a first coefficient 311 (represented by “a”), a second coefficient 312 (represented by “b”), a third coefficient 313 (represented by “c”), and a fourth coefficient 314 (represented by “d”). From the group of four coefficients 310, the coefficient with the smallest nonzero value is determined. Referring to FIG. 3, the first coefficient 311, “a”, may be determined as the smallest nonzero coefficient. The remaining nonzero coefficients (e.g., 312, 313, 314) in the group of four coefficients 310 may be retrained to be a power-of-two of the first coefficient 311. Referring to FIG. 3, the second coefficient 312, ‘b”, may be retrained as coefficient 322 to be a power-of-two (“−2a”) of the first coefficient 311. Similarly, the third coefficient 313, “c”, may be retrained as coefficient 323 to be a power-of-two (“−8a”) of the first coefficient 311, and the fourth coefficient 314, “d”, may be retrained as coefficient 324 to be a power-of-two (“4a”) of the first coefficient 311. In this way, each group of four coefficients in the pruned weight matrix 220 may be retrained to generate a retrained weight matrix. The retrained weight matrix may then be compressed.

FIG. 4 is a diagram illustrating compression of a weight matrix, according to various embodiments. For example, the device 100 may obtain the pruned weight matrix 220 and retrain the coefficients in each group of four coefficients to generate the retrained weight matrix, and the device 100 may compress the retrained weight matrix to generate the compressed weight matrix 230, nonzero flag array 240, the sign flag array 250, and the left-shift flag array 260. The nonzero flag array 240 may be a one-bit array used to keep track of the nonzero coefficients in the original matrix, as discussed above with respect to FIG. 2; the sign flag array 250 may be a one-bit array used to keep track of the sign of the nonzero coefficients in the original matrix; and the left-shift flag array 260 may be a two-bit array used to keep track of the power-of-two relationship in each group of four coefficients.

As shown in FIG. 4, the group of four coefficients 310 may be compressed to a single coefficient 430 (“a”) in the compressed weight matrix 230, thereby achieving a quarter the size of the original weight matrix. Referring still to FIG. 4, the nonzero flags 440 are values in the nonzero flag array 240 that correspond to the group of four coefficients 310, the sign flags 450 are values in the sign flag array 240 that correspond to the group of four coefficients 310, and the left-shift flags 460 are values in the left-shift flag array 260 that correspond to the group of four coefficients 310.

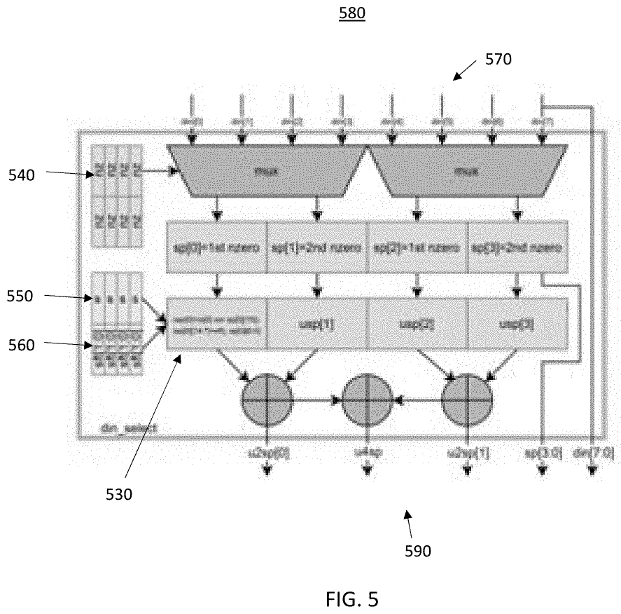

FIG. 5 is a diagram illustrating a matrix multiplication operation in a unified sparse tensor core, according to various embodiments. The unified sparse tensor core 580 may be controlled to perform the matrix multiplication as part of an inference operation of a trained neural network. The unified sparse tensor core 580 may be provided an input comprising corresponding values in the compressed weight matrix 230 (i.e., weight coefficients), nonzero flag array 240 (i.e., nonzero flags), sign flag array 250 (i.e., sign flags), left-shift flag array 260 (i.e., left-shift flags), and input activation matrix 270 (i.e., input activation coefficients).

As shown in FIG. 5, the weight coefficients 530, nonzero flags 540, sign flags 550, left-shift flags 560, and input activation coefficients 570 may be input to the unified sparse tensor core 580, and output activation coefficients 590 may be obtained as an output of the unified sparse tensor core 580. The nonzero flags 540 may be used to select only the nonzero values in the input activation coefficients 570. In this way, multiplication operations corresponding to zero value coefficients in the input activation coefficients 570 may be skipped to achieve twice the throughput of a conventional tensor core. A plurality of multiplication operations between the selected input activation coefficients and the weight coefficients 530 may be converted into a single multiplication operation and multiple addition operations, based on the sign flags 550 and left-shift flags 560. In this way, only half of the multipliers in the unified sparse tensor core 580 are needed to compute each dot product result, and the unified sparse tensor core 580 may achieve four times the throughput of a conventional tensor core.

In some embodiments, the absolute value of all nonzero coefficients in each two groups of four coefficients in the pruned weight matrix 220 may be retrained to generate the unified pruned weight matrix. The absolute value of all nonzero coefficients in each two groups of four coefficients may be retrained to be a power-of-two of the smallest nonzero coefficient in the two groups of four coefficients. By retraining the nonzero coefficients in each two groups of four coefficients, the unified sparse tensor core 580 may be provided double the input, and convert multiple independent multiplication operations corresponding to double the input activation coefficients to one multiplication operation and multiple addition operations. In this way, only a quarter of the multipliers in the unified sparse tensor core 580 are needed to compute each dot product result, and the unified sparse tensor core 580 may achieve eight times the throughput of a conventional tensor core.

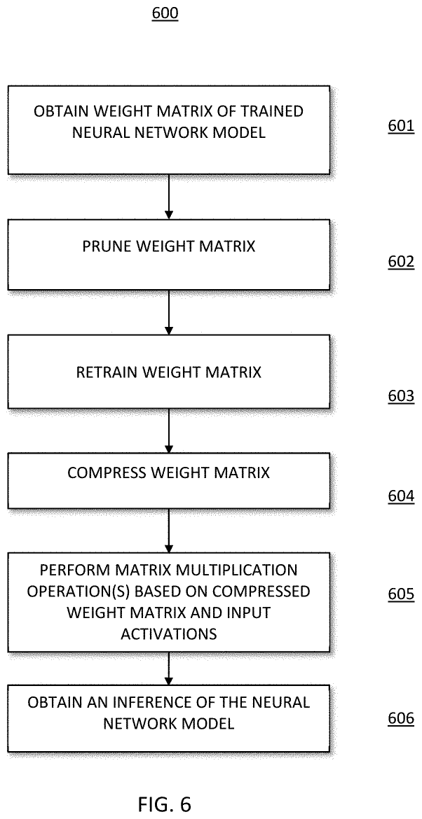

FIG. 6 is a flow diagram illustrating a method 600 for accelerating a neural network model, according to various embodiments. As shown in FIG. 6, at 601, the method 600 includes obtaining a weight matrix of a trained neural network model. For example, the device 100 may obtain the weight matrix 210 that corresponds to a trained neural network model. The weight matrix 210 may be referred to as an original weight matrix. The weight matrix 210 may include a set of coefficient values corresponding to the trained neural network model.

At 602, the method 600 includes pruning the weight matrix. For example, the device 100 may prune the weight matrix 210 to meet a 2:4 sparse pattern, where at least two coefficients of the weight matrix are nonzero in each group of four coefficients of the weight matrix.

At 603, the method 600 includes retraining the weight matrix. For example, the device 100 may retrain the pruned weight matrix 220. The device 100 may retrain the pruned weight matrix 220 by determining a smallest nonzero coefficient in each group of four coefficients of the pruned weight matrix 220, and retraining an absolute value of each nonzero coefficient in each group of four coefficients to be a power-of-two of the smallest nonzero coefficient in the group.

At 604, the method 600 includes compressing the weight matrix. For example, the device 100 may compress the retrained weight matrix. The device 100 may compress the retrained weight matrix to a quarter size of the original weight matrix, and generate a nonzero flag array corresponding to the compressed weight matrix, a sign flag array corresponding to the compressed weight matrix, and a left-shift flag array corresponding to the compressed weight matrix. The nonzero flag array may be a one-bit array that is used to keep track of nonzero coefficients in the original weight matrix, the sign flag array may be a one-bit array that is used to keep track of a sign of the nonzero coefficients in the original weight matrix, and the left-shift flag array may be a two-bit array that is used to keep track of a power-of-two relationship in each group of four coefficients.

At 605, the method 600 includes performing matrix multiplication operation(s) based on the compressed weight matrix and input activations of the neural network model. For example, the device 100 may perform a matrix multiplication operation based on inputting the compressed weight matrix and a set of input activations to the trained neural network model. The device 100 may select input activations from the set of input activations, based on the nonzero flag array, so that only input activations that correspond to the nonzero flag array are selected. The device 100 may perform the matrix multiplication operation on the selected input activations, where multiplication operations corresponding to unselected input activations are skipped. In this way, a plurality of multiple independent multiplication operations, that correspond to an inference operation of the trained neural network model, are each converted to single multiplication operation and multiple addition operations, and a plurality of the converted single multiplication operations are performed simultaneously.

At 606, the method 600 includes obtaining an inference of the neural network model. For example, the device 100 may obtain a result of the matrix multiplication operation corresponding to each of a plurality of groups of four coefficients in the weight matrix. The device 100 may determine an output of an inference operation of the trained neural network model based on the plurality of matrix multiplication results.

According to various example embodiments, a neural network model may be accelerated using a uniform pattern based sparse tensor core operation for neural network acceleration. The unified sparse tensor core operation combines a fine-grained structured sparsity technique with a weight unification technique, to achieve higher inference throughput. Provided are systems and methods for performing a high-performance general matrix-matrix multiplication (GEMM) by pruning, retraining, and compressing a weight matrix such that multiple independent multiplication operations may be converted to a single multiplication operation and multiple addition operations. In this way, an inference operation of the neural network model (that use matrix multiplication intensively) may be accelerated.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flow diagram and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flow diagram and/or block diagram block or blocks.

The flow and block diagrams in the Figures illustrate the architecture, functionality, and operation of possible implementations of systems, methods, and computer readable media according to various embodiments. In this regard, each block in the flow diagram or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flow diagram illustration, and combinations of blocks in the block diagrams and/or flow diagram illustration, may be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for accelerating a neural network model, performed by at least one processor and comprising:
obtaining an original weight matrix corresponding to a trained neural network model;
pruning the original weight matrix to generated a pruned weight matrix, wherein at least two coefficients are nonzero in each group of four coefficients in the pruned weight matrix;
retraining nonzero coefficients in the pruned weight matrix;
compressing the retrained weight matrix; and
performing a matrix multiplication operation based on inputting the compressed weight matrix and a set of input activations to the trained neural network model.

2. The method of claim 1 wherein pruning the original weight matrix comprises:
pruning the weight matrix to meet a 2:4 sparse pattern.

3. The method of claim 1, wherein retraining the nonzero coefficients in the pruned weight matrix comprises:
determining a smallest nonzero coefficient in each group of four coefficients of the pruned weight matrix; and
retraining an absolute value of each nonzero coefficient in each group of four coefficients to be a power-of-two of the smallest nonzero coefficient in the group.

4. The method of claim 1, wherein compressing the retrained weight matrix comprises:
compressing the retrained weight matrix to be a quarter size of the original weight matrix;
generating a nonzero flag array corresponding to the compressed weight matrix;
generating a sign flag array corresponding to the compressed weight matrix; and
generating a left-shift flag array corresponding to the compressed weight matrix.

5. The method of claim 4, wherein the nonzero flag array is a one-bit array that is used to keep track of nonzero coefficients in the original weight matrix, the sign flag array is a one-bit array that is used to keep track of a sign of the nonzero coefficients in the original weight matrix, and the left-shift flag array is a two-bit array that is used to keep track of a power-of-two relationship in each group of four coefficients.

6. The method of claim 4, wherein performing a matrix multiplication operation based on inputting the compressed weight matrix and a set of input activations to the trained neural network model comprises:
selecting input activations from the set of input activations, based on the nonzero flag array, wherein only input activations that correspond to the nonzero flag array are selected; and
performing the matrix multiplication operation on the selected input activations, wherein multiplication operations corresponding to unselected input activations are skipped.

7. The method of claim 6, wherein performing the matrix multiplication operation on the selected input activations comprises:
converting multiple independent multiplication operations to a single multiplication operation and multiple addition operations, based on the sign flag array and the left-shift flag array; and
performing the single multiplication operation and multiple addition operations using the selected input activations, based on the sign flag array and the left-shift flag array.

8. The method of claim 7, wherein a plurality of multiple independent multiplication operations, that correspond to an inference operation of the trained neural network model, are each converted to single multiplication operation and multiple addition operations, and a plurality of the single multiplication operations are performed simultaneously.

9. The method of claim 1, further comprising:
obtaining an output of the neural network model based on the matrix multiplication operation, the output corresponding to an inference operation of the neural network model.

10. A device for accelerating a neural network model, comprising:
a memory storing program code; and
at least one processor configured to execute the program code and operate as instructed by the program code, the program code including:
obtaining code configured to cause the at least one processor to obtain an original weight matrix corresponding to a trained neural network model;
pruning code configured to cause the at least one processor to prune the original weight matrix;
retraining code configured to cause the at least one processor to retrain nonzero coefficients in the pruned weight matrix;
compressing code configured to cause the at least one processor to compress the retrained weight matrix; and
matrix multiplication code configured to cause the at least one processor to perform a matrix multiplication operation based on inputting the compressed weight matrix and a set of input activations to the trained neural network model.

11. The device of claim 10, wherein the program code further includes:
determining code configured to cause the at least one processor to determine a smallest nonzero coefficient in each group of four coefficients of the pruned weight matrix; and
the retraining code is configured to cause the at least one processor to retrain an absolute value of each nonzero coefficient in each group of four coefficients to be a power-of-two of the smallest nonzero coefficient in the group.

12. The device of claim 10, wherein the compressing code is configured to cause the at least one processor compress the retrained weight matrix to be a quarter size of the original weight matrix; and
wherein the program code further includes flag array generating code to cause the at least one processor to:
generate a nonzero flag array corresponding to the compressed weight matrix;
generate a sign flag array corresponding to the compressed weight matrix; and
generate a left-shift flag array corresponding to the compressed weight matrix.

13. The device of claim 12, wherein the program code includes:
input selection code configured to cause the at least one processor to select input activations from the set of input activations, based on the nonzero flag array, wherein only input activations that correspond to the nonzero flag array are selected; and
wherein the matrix multiplication code is configured to cause the at least one processor to perform the matrix multiplication operation on the selected input activations, and the multiplication operation corresponding to unselected input activations is skipped.

14. The device of claim 13, wherein the program code includes:
converting code configured to cause the at least one processor to convert multiple independent multiplication operations to a single multiplication operation and multiple addition operations, based on the sign flag array and the left-shift flag array; and
the matrix multiplication code is configured to cause the at least one processor to perform the single multiplication operation and multiple addition operations using the selected input activations, based on the sign flag array and the left-shift flag array.

15. The device of claim 14, wherein a plurality of multiple independent multiplication operations, that correspond to an inference operation of the trained neural network model, are each converted to single multiplication operation and multiple addition operations, and a plurality of the single multiplication operations are performed simultaneously.

16. The device of claim 12, wherein the program code includes:
output obtaining code configured to cause the at least one processor to obtain an output of the neural network model based on the matrix multiplication operation, the output corresponding to an inference operation of the neural network model.

17. A non-transitory computer readable medium for storing computer readable program instructions which are executable by a processor to perform operations for accelerating a neural network model, the operations comprising:
obtaining an original weight matrix corresponding to a trained neural network model;
pruning the original weight matrix;
retraining nonzero coefficients in the pruned weight matrix;
compressing the retrained weight matrix;
performing a matrix multiplication operation based on inputting the compressed weight matrix and a set of input activations to the trained neural network model; and
obtaining an output of the neural network model based on the matrix multiplication operation, the output corresponding to an inference operation of the neural network model.

18. The non-transitory computer readable medium of claim 17, wherein the operations further comprise:
determining a smallest nonzero coefficient in each group of four coefficients of the pruned weight matrix; and
retraining an absolute value of each nonzero coefficient in each group of four coefficients to be a power-of-two of the smallest nonzero coefficient in the group.

19. The non-transitory computer readable medium of claim 17, wherein the operations further comprise:
compressing the retrained weight matrix to be a quarter size of the original weight matrix;
generating a nonzero flag array corresponding to the compressed weight matrix;
generating a sign flag array corresponding to the compressed weight matrix; and
generating a left-shift flag array corresponding to the compressed weight matrix.

20. The non-transitory computer readable medium of claim 19, wherein the operations further comprise:
converting multiple independent multiplication operations to a single multiplication operation and multiple addition operations, based on the sign flag array and the left-shift flag array; and
performing the single multiplication operation and multiple addition operations using the selected input activations, based on the sign flag array and the left-shift flag array.
